(19) United States
(12) Patent Application Publication
(10) Pub. No.: US 2009/0236577 A1
(43) Pub. Date: Sep. 24, 2009

(54) Dual Mode Jack Foot

(75) Inventors: Michael John Pollock, Boswell, PA (US); Vaughan Gordon Stevenson, Havelock, NC (US); John Ellsworth Gover, JR., New Florence, PA (US); David Shawn Rose, Windber, PA (US)

Correspondence Address: BUCHANAN INGERSOLL & ROONEY PC, P.O. BOX 1404, ALEXANDRIA, VA, 22313-1404, US

(73) Assignee: Concurrent Technologies Corporation, Johnstown, PA (US)

(21) Appl. No.: 12/407,908

(22) Filed: Mar. 20, 2009

Related U.S. Application Data
(60) Provisional application No. 61/070,226, filed on Mar. 20, 2008.

(51) Int. Cl. B60S 9/02

(52) U.S. Cl. 254/418

(57) ABSTRACT

The dual mode jack foot of the present invention is designed for attachment to the base of most commercially available trailer jacks. The inventive jack foot includes a housing pivotally attached to an end of a trailer jack, and first and second types of trailer support mechanisms attached to the housing approximately 90-degrees apart. The housing is pivotable between a first position wherein the first type of trailer support mechanism is deployed for use, and a second position wherein the second type of trailer support mechanism is deployed for use.

### CROSS REFERENCE TO RELATED APPLICATIONS

This application claims the benefit of co-pending Provisional Patent Application Ser. No. 61/070,226 entitled “Dual Mode Mobile Leveling Jack Foot”, filed on Mar. 20, 2008, the entire disclosure of which is incorporated by reference herein.

### FIELD OF THE INVENTION

The present invention is directed toward jacks for use on equipment such as trailers and, more particularly, toward a dual mode jack foot capable of easy switching between a first position wherein a first type of trailer support mechanism (e g, foot pad) is deployed for supporting the trailer, and a second position wherein a second type of trailer support mechanism (e g, caster wheel) is deployed for supporting the trailer.

### BACKGROUND OF THE INVENTION

Trailers and jacks are well-known in the prior art. Trailers may be utilized to haul various types of vehicles, equipment and cargo. Trailers may take virtually any configuration depending upon the type of vehicle, equipment, cargo, etc. they are designed to transport.

Typical trailers will include a frame for supporting the item(s) to be transported and a chassis supporting the frame. An axle is provided beneath the chassis for wheels which contact a road surface. A tongue is provided at the head of the trailer frame for connection to a vehicle. Trailers also typically have a jack connected to the frame to support the tongue during hitching and unhitching to a vehicle. Jacks typically include a crank (either manual or automated) that will extend the jack to raise the trailer frame and retract the jack to lower the trailer frame, which aids in hitching and unhitching the trailer to a vehicle. The distance of movement of the jack between its extended and retracted positions is generally referred to as “travel”. Conventional jacks will have anywhere between 6-13 inches of travel. The bottom end of the jack which contacts the ground typically includes either a wheel (e.g., a caster wheel) or a flat foot pad.

A wheel jack (a jack which includes a wheel at its bottom end) permits movement of the trailer once it is unhitched from the vehicle. Conversely, a foot jack (a jack which includes a flat toot pad at its bottom end) will fix the location of the trailer and provide for a secure and non-moveable trailer. Each of the wheel and foot jacks has its advantages and disadvantages.

While a wheel jack will permit a user to move the trailer on flat ground, the wheel will often become embedded in soft ground or soft asphalt if the trailer is unhitched at such a location. While a foot jack will have greater surface area for greater stability on soft ground, the trailer cannot be readily moved without lifting the foot pad off the ground.

The present invention is directed toward overcoming one or more of the above-mentioned problems.

### SUMMARY OF THE INVENTION

The dual mode jack foot of the present invention is designed for attachment to the base of most commercially available trailer jacks. The inventive jack foot includes a housing pivotally attached to an end of a trailer jack, and first and second types of trailer support mechanisms attached to the housing approximately 90-degrees apart. The housing is pivotable between a first position wherein the first type of trailer support mechanism is deployed for use, and a second position wherein the second type of trailer support mechanism is deployed for use.

In one form, the housing includes an opening for receiving the end of the trailer jack. The housing is pivotally attached to the end of the trailer jack by a pin extending through aligned apertures in the housing and the trailer jack. The pin provides a pivot point for the inventive jack foot enabling it to be rotated quickly and easily between the first and second positions.

In a further form, the end of the trailer jack includes a position retaining aperture extending there through. The housing includes first and second apertures corresponding to the first and second positions, respectively, such that with the housing in the first position the first aperture in the housing is aligned with the position retaining aperture in the trailer jack, and with the housing in the second position the second aperture of the housing is aligned with the position retaining aperture in the trailer jack. The inventive jack foot is held in either the first or second position by a pin extending through the aligned apertures.

Some advantages of the inventive jack foot include, but are not limited to:
Heavy duty construction for large commercial, industrial and military applications.
When a foot pad is utilized, the inventive jack foot is meant to keep the trailer in place. The inventive design does not mount to the caster axle and therefore the caster swivel is not able to rotate and allow the trailer to move side to side such as, for example, in U.S. Pat. No. 6,659,696.
Since the caster of the present invention is mounted to a plate separate from the jack, various caster wheel arrangements and sizes can be attached to the mounting plate, including dual wheel casters. Additionally, the present invention provides the option to remove the caster and provide a stake foot to hold the trailer on sloped terrains or simply to ensure that it is stable when detached from the tow vehicle Alternately, the stake can be mounted onto the foot pad in order to provide both caster and stake features.
Since the caster wheel and foot pad are mounted to the same rotation unit (housing), the caster wheel does not have to be aligned to deploy the foot pad.
The inventive design leaves the caster wheel fully exposed to operate over rough terrains and obstacles.
Since the present invention allows operation in rough environments, the fact that the foot pad does not rotate on the caster wheel axle means it will be less susceptible to operational failure due to weeds, grass and other debris getting wrapped between the caster wheel and the foot pad.
The inventive jack foot allows for larger foot pads (square, rectangular, etc.) to be implemented since it swings the foot pad 90-degrees from the caster wheel, and vice versa.
The inventive jack foot is less susceptible to packing with mud since the caster wheel is rotated up and away when the foot pad is deployed and in position for use, thus keeping it clean and functional.

It is an object of the present invention to provide a dual mode jack foot for the support of items such as trailers and other mobile systems. The dual mode jack foot can be attached to the base of most commercially available trailer jacks and generally consists of a housing having a foot pad and a mounting point for a caster wheel or other device, such as a stake. The dual mode jack foot can be rotated between first and second positions to deploy either the foot pad or the caster wheel for use. In the first position, the inventive jack foot can deploy the foot pad for use on soft surfaces or surfaces where high flotation is necessary. In the second position, the inventive jack foot can deploy the caster wheel for use on hard surfaces which provides the ability to move the trailer without an attached vehicle. Using the mounting point with a stake rather than the caster wheel will allow the trailer to be pinned into location on sloped terrains. Rotation of the inventive dual mode jack foot between the first and second positions can be accomplished quickly and easily without the use of tools.

Other objects, aspects and advantages of the present invention can be obtained from a study of the specification, the drawings, and the appended claims.

### BRIEF DESCRIPTION OF THE DRAWINGS

FIG. 1a is a side view of the inventive dual mode jack foot attached to a first type of conventional jack, with the foot pad deployed for use;

FIG. 1b is a side view of the inventive dual mode jack foot attached to the first type of conventional jack, with the caster wheel deployed for use;

FIG. 2a is a side view of the inventive dual mode jack foot attached to a second type of conventional jack, with the foot pad deployed for use;

FIG. 2b is a side view of the inventive dual mode jack foot attached to the second type of conventional jack, with the caster wheel deployed for use;

FIG. 3a is a side view of the inventive dual mode jack foot attached to a third type of conventional jack, with the foot pad deployed for use;

FIG. 3b is a side view of the inventive dual mode jack foot attached to the third type of conventional jack, with the caster wheel deployed for use;

FIG. 4 is a side view of a tubular member provided in a conventional jack housing;

FIG. 5 illustrates side views rotated 90-degrees of the tubular member shown in FIG. 4 after the foot pad has been removed;

FIG. 6 is a top view of the foot pad after removal from the tubular member;

FIG. 7 is a side view of the foot pad after removal from the tubular member;

FIG. 8 is a side view of the inventive jack foot with caster attachment plate;

FIG. 9 is a front view of the inventive jack foot with caster attachment plate;

FIG. 10 is a top view of the inventive jack foot with caster attachment plate;

FIG. 11 is a perspective view of the inventive jack foot with caster attachment plate; and

FIG. 12 is a side view of the inventive jack foot with a caster wheel attached thereto.

### DETAILED DESCRIPTION OF THE INVENTION

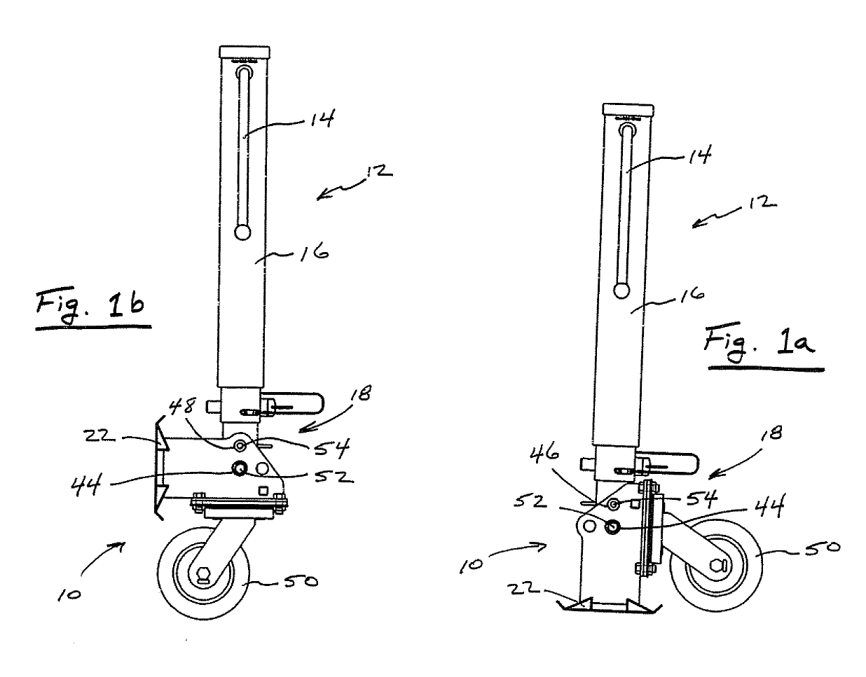

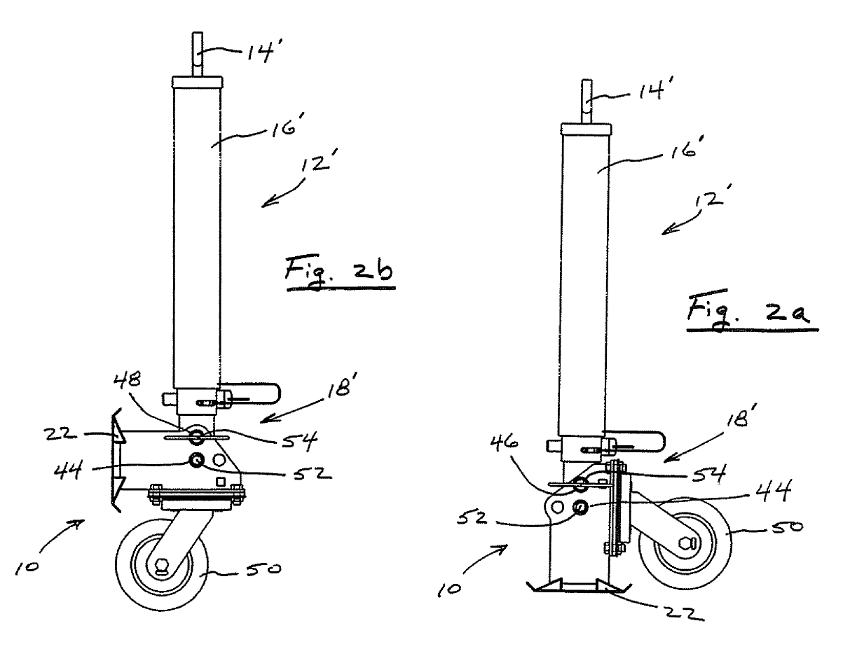

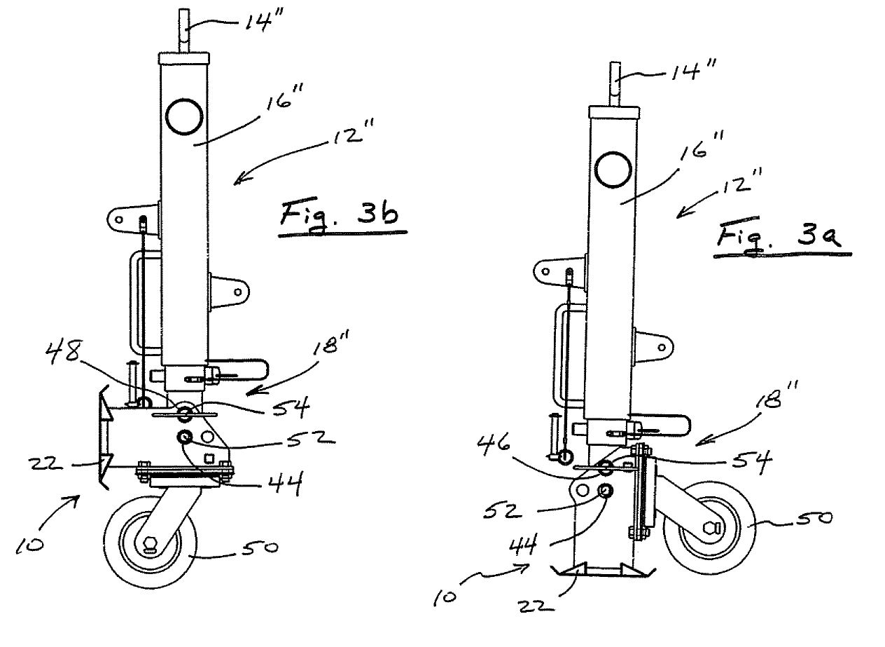

As shown in FIGS. 1-3, the dual mode jack foot 10 of the present invention can be utilized with a variety of different types of conventional jacks. As shown in FIGS. 1a and 1b, the jack 12 includes a side crank 14 which is used to extend and retract the jack to provide the travel typically associated with jacks. As shown in FIGS. 2a and 2b, the jack 12′ includes a top crank 14′ which is used to extend and retract the jack 12′. Similarly, the jack 12″ shown in FIGS. 3a and 3b also includes a top crank 14″ for extending and retracting the jack 12″ The jacks, 12, 12′, 12″ each typically include a housing 16, 16′, 16″ and tubular members provided within the housing 16, 16′, 16″. The tubular members are operably connected to the jack crank and conventionally extend out of and retract into the jack to provide a certain amount of travel for the jack. As illustrated in FIGS. 1-3, the dual mode jack foot 10 of the present invention is attached to a bottom end 18, 18′, 18″ of the trailer jacks. The jacks 12, 12′, 12″ themselves are conventionally attached to a trailer flame by welding or other attachment mechanisms as is well-known in the art.

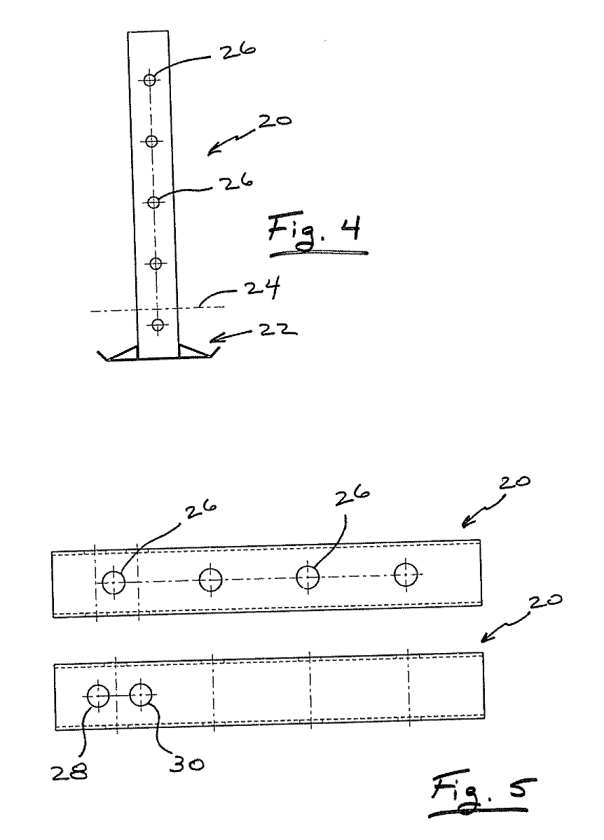

The dual mode jack foot 10 of the present invention can be a pre-made item or can be made from an existing foot jack. FIG. 4 illustrates a tubular member 20 of a typical foot jack. The tubular member 20 extends into the housing of the jack and is operably connected to the crank for extension and retraction of the jack. The bottom of the tubular member 20 includes a foot pad 22. The tubular member 20 is cut at the dotted line 24 to separate the foot pad 22 from the tubular member 20. The apertures 26 provided in the tubular member 20 are for connection to other tubular members within the housing of a conventional jack. While the foot pad 22 may be detached from the tubular member 20 at virtually any place along the length of the tubular member 20, in one form the cut is made approximately 2.75 inches from the bottom of the foot pad 22. While the tubular member 20 is shown having a square cross-section, one skilled in the art will appreciate that the tubular member 20 may have a variety of geometric cross-sectional shapes.

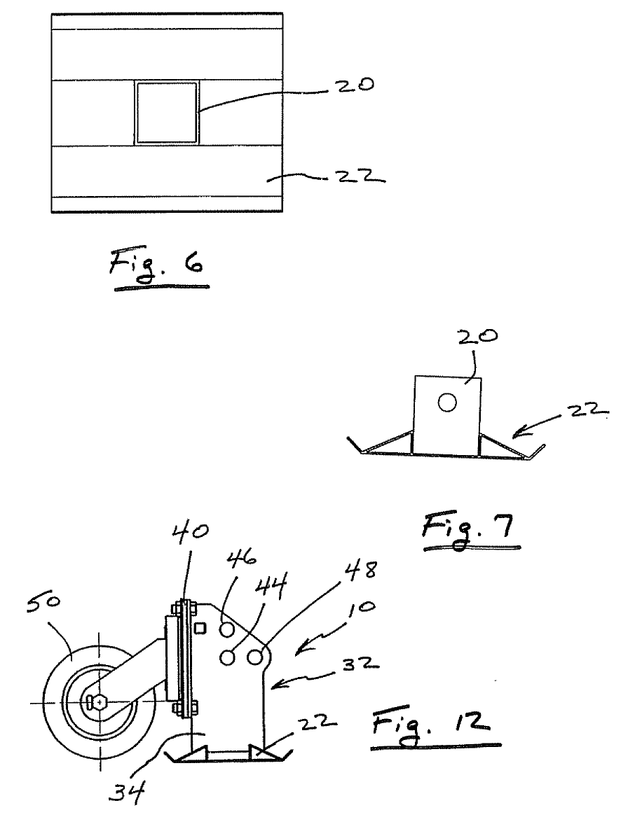

As shown in FIG. 5 apertures, are formed in the cut tubular member 20. A first aperture 28 is cut in the tubular member 20 approximately 1.5 inches from the lower end. A second aperture 30 is cut above the aperture 28. Apertures 28 and 30 are cut in the tubular member 20 at approximately a 90-degree angle to the apertures 26 provided in the tubular member 20, Aperture 28 acts as the pivot point for the inventive jack foot 10, while aperture 30 acts as a position retaining aperture, as will be more fully described herein. As shown in FIGS. 6-7, once the foot pad 22 is removed, it will still include a portion of the tubular member 20 extending from the center thereof.

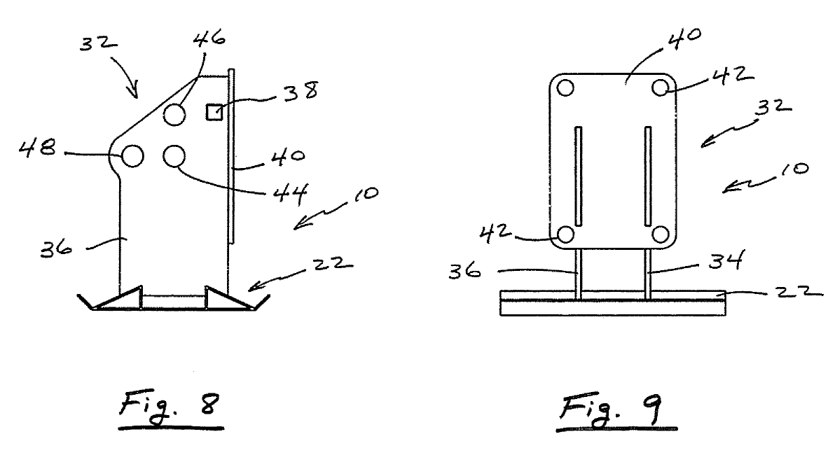

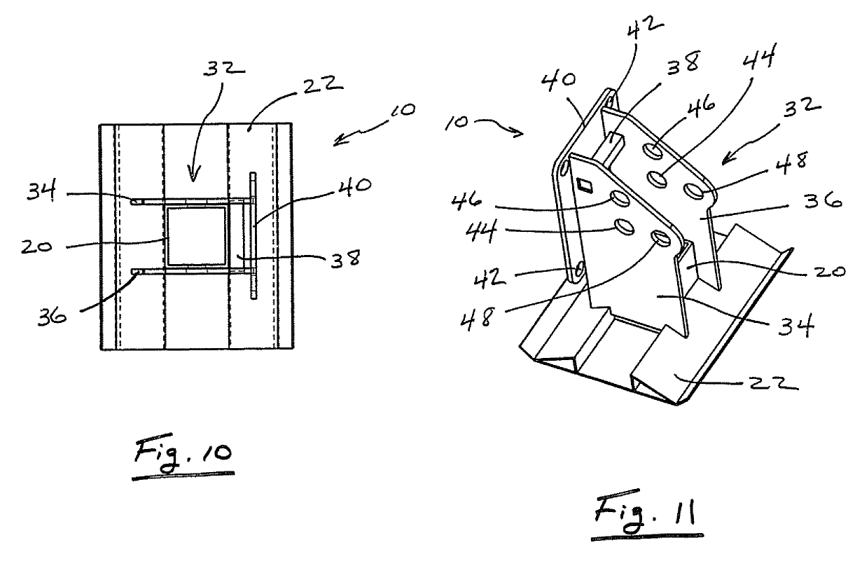

Referring to FIGS. 8-11, to construct the inventive dual mode jack foot 10 of the present invention, a housing 32 is attached to the foot pad 20. The housing 32 includes plates 34 and 36 attached to opposite sides of the tubular member 20 extending from the foot pad 22. The plates 34, 36 may be welded to the tubular member 20 and/or the foot pad 22, or attached by other conventional attached mechanisms. A spacer bar 38 extends through corresponding apertures formed in the plates 34 and 36, and is mounted (via welding or other conventional attachment mechanisms) between the plates 34 and 36 for added stability and as a rotation stop. A mounting plate 40 for a caster wheel or other device is attached to an end of the side plates 34, 36. For attachment, the ends of the side plates 34, 36 have extended portions which fit into cut outs formed in the mounting plate 40. Then the mounting plate 40 is welded to the plates 34, 36 or attached by other conventional attachment mechanisms. The mounting plate 40 includes apertures 42 formed therein for mounting a caster wheel or other device thereto.

Three apertures are provided through the side plates 34 and 36. Aperture 44 acts as a pivot point for the inventive jack foot 10, Apertures 46 and 48 act as position retaining apertures to retain the inventive jack foot 10 in either the first or second positions, respectively.

As shown in FIG. 12, a conventional caster wheel 50 is mounted to the mounting plate 40 via conventional nut and bolt fasteners. It should be understood that other types of devices, such as stakes, etc., may be mounted to the mounting plate 40 depending upon the type of support required for the trailer.

Referring to FIGS. 1-3, to attach the inventive jack foot 10 to the jack 12, 12′, 12″, the tubular member 20 is received in the housing 32 and the pivot aperture 44 in the jack foot housing 32 is aligned with the pivot aperture 28 in the tubular member 120. A retaining pin 52 or other similar member is inserted through the apertures 44 and 28 and conventionally locked in place. The pivot aperture 28 in the tubular member 20 is cut such that there will be clearance between the end of the tubular member 20 extending into the jack foot housing 32 and the end of the portion of the tubular member 20 remaining on the foot pad 22 to allow for rotation of the inventive jack foot 10.

FIGS. 1a, 2a and 3a illustrate the inventive jack foot 10 attached to a jack 12, 12′, 12″ with the foot pad 22 deployed for use. To place the jack foot 10 in this position, the jack foot 10 is rotated to the position shown in FIGS. 1a, 2a and 3a such that the position retaining aperture 46 in the jack foot housing 32 is aligned with the position retaining aperture 30 in the tubular member 20. A retaining pin 54 or other similar member is inserted through the apertures 46 and 30 and conventionally locked in places. In this first position, the foot pad 22 is deployed for use and the caster wheel 50 is rotated 90-degrees and is rolled up and away. In this manner, the caster wheel 50 can be kept clean and functional for use.

FIGS. 1b, 2b and 3b illustrate the inventive jack foot 10 attached to a jack 12, 12′, 12″ with the caster wheel 50 deployed for use. When the caster wheel 50 is desired for deployment, the retaining pin 54 is removed and the jack foot 10 is rotated 90-degrees to align the position retaining aperture 48 in the jack foot housing 32 with the position retaining aperture 30 in the tubular member 20. The retaining pin 54 or other similar member is inserted through the apertures 48 and 30 and conventionally locked in place to retain the jack foot in this second position. In this second position, as shown in FIGS. 1b, 2b and 3b, the caster wheel 50 is deployed for use and the trailer may be moved on a flat surface. The foot pad 22 is rotated 90-degrees and is moved up and away and does not interfere with movement of the trailer.

As one skilled in the art will appreciate, the inventive dual mode jack foot 10 allows ease of operation between deployment of either the foot pad 22 or the caster wheel 50 (or other device). In one form, the caster wheel 50 may be removed and replaced with a stake or other type of support mechanism, depending upon the desired support required for the trailer.

While the present invention has been described with the particular reference to the drawings, it should be understood that various modifications could be made without departing from the spirit and scope of the present invention. For instance, while position retaining apertures are described a being formed through the jack foot housing and tubular member of the jack, other ways and means of securing the inventive jack foot into position may be implemented without departing from the spirit and scope of the present invention. Those skilled in the art will appreciate the various modifications and alterations could be developed in light of the overall teachings of the disclosure. The presently preferred embodiments described herein are meant to be illustrative only and not limiting as to the scope of the invention which is to be given the full breadth of the appended claims and any and all equivalents thereof.

We claim:

1. A dual mode jack foot for attachment to an existing trailer jack, the dual mode jack foot comprising:
a housing pivotally attached to an end of the trailer jack;
a first type of trailer support mechanism attached to the housing; and
a second type of trailer support mechanism attached to the housing,
wherein the housing is pivotable between a first position such that the first type of trailer support mechanism is deployed for use, and a second position such that the second type of trailer support mechanism is deployed for use.

2. The dual mode jack foot of claim T, wherein the housing includes an opening for receiving the end of the trailer jack, and wherein the housing is pivotally attached to the end of the trailer jack by a pin extending through aligned apertures in the housing and the trailer jack, the pin providing a pivot point for the dual mode jack foot.

3. The dual mode jack foot of claim 2, wherein the end of the trailer jack includes a position retaining aperture extending there through, and wherein the housing includes first and second apertures corresponding to the first and second positions respectively, such that with the housing in the first position the first aperture in the housing is aligned with the position retaining aperture in the trailer jack and held in place by a pin extending there through, and with the housing in the second position the second aperture in the housing is aligned with the position retaining aperture in the trailer jack and held in place by a pin extending there through.

4. The dual mode jack foot of claim 1, wherein the first type of trailer support mechanism comprises a caster wheel, and wherein the second type of trailer support mechanism comprises a foot pad.

5. The dual mode jack foot of claim 1, wherein the housing is pivotable 90-degrees between the first and second positions.

6. A dual mode jack foot for attachment to an existing trailer jack, the dual mode jack foot comprising:
a housing pivotally attached to an end of the trailer jack;
a first type of trailer support mechanism attached to the housing; and
a second type of trailer support mechanism attached to the housing and spaced 90-degrees from the first type of trailer support mechanism.

7. The dual mode jack foot of claim 6, wherein the housing includes an opening for receiving the end of the trailer jack, and wherein the housing is pivotally attached to the end of the trailer jack by a pin extending through aligned apertures in the housing and the trailer jack, the pin providing a pivot point for the dual mode jack foot such that the dual mode jack foot is pivotable between a first position such that the first type of trailer support mechanism is deployed for use, and a second position such that the second type of trailer support mechanism is deployed for use.

8. The dual mode jack foot of claim 7, wherein the end of the trailer jack includes a position retaining aperture extending there through, and wherein the housing includes first and second apertures corresponding to the first and second positions respectively, such that with the housing in the first position the first aperture in the housing is aligned with the position retaining aperture in the trailer jack and held in place by a pin extending there through, and with the housing in the second position the second aperture in the housing is aligned with the position retaining aperture in the trailer jack and held in place by a pin extending there through.

9. The dual mode jack foot of claim 6, wherein the first type of trailer support mechanism comprises a caster wheel, and wherein the second type of trailer support mechanism comprises a foot pad.

10. A dual mode jack foot for attachment to an existing trailer jack, the dual mode jack foot comprising:
a housing pivotally attached to an end of the trailer jack;
a foot pad attached to the housing; and
a mounting plate attached to the housing,
wherein the housing is pivotable between a first position such that the foot pad is deployed for use, and a second position such that a trailer support mechanism attached to the mounting plate is deployed for use.

11. The dual mode foot jack of claim 10, wherein the trailer support mechanism is selected from the group consisting of a caster wheel and a stake.

12. The dual mode jack foot of claim 10, wherein the housing includes an opening for receiving the end of the trailer jack, and wherein the housing is pivotally attached to the end of the trailer jack by a pin extending through aligned apertures in the housing and the trailer jack, the pin providing a pivot point for the dual mode jack foot.

13. The dual mode jack foot of claim 12, wherein the end of the trailer jack includes a position retaining aperture extending there through, and wherein the housing includes first and second apertures corresponding to the first and second positions respectively, such that with the housing in the first position the first aperture in the housing is aligned with the position retaining aperture in the trailer jack and held in place by a pin extending there through, and with the housing in the second position the second aperture in the housing is aligned with the position retaining aperture in the trailer jack and held in place by a pin extending there through.

14. The dual mode jack foot of claim 10, wherein the housing is pivotable 90-degrees between the first and second positions.
